(19) United States
(12) Patent Application Publication
(10) Pub. No.: US 2006/0162078 A1
(43) Pub. Date: Jul. 27, 2006

(54) Electric mattress

(76) Inventor: Heng-Tai Chang, Taichung City (TW)

Correspondence Address: BACON & THOMAS, PLLC, 625 SLATERS LANE, FOURTH FLOOR, ALEXANDRIA, VA, 22314, US

(21) Appl. No.: 11/039,821

(22) Filed: Jan. 24, 2005

(51) Int. Cl. A61G 7/015

(52) U.S. Cl. 5/616; 5/618; 5/621

(57) ABSTRACT

An electric mattress comprises a main member made of an elastic material. A frame has a base, a plurality of shafts in the main member and a plurality of elastic members on the shafts. The shafts are rotated to flex and extend the main member. A driving device is connected to the shafts to drive the shafts for rotation respectively, and a control device is electrically connected to the driving device for operation. As a result, user has to operate the control device to adjust the slope of the main member.

### BACKGROUND OF THE INVENTION

1. Field of the Invention

The present invention relates generally to a mattress, and more particularly to an electric mattress with function of adjustment of slope.

2. Description of the Related Art

A conventional mattress usually is made of an elastic material, such as foaming material or with springs therein, to support human's body in a full-attachment condition. Some mattresses are provided with a frame therein to help user lying or sitting thereon. The frame is consisted of a plurality of shafts, each of which is rotated independently to flex and extend the mattress according to the control.

To adjust the slope of the conventional mattress, a side of the mattress has to be elevated to rotate the shafts to desire positions respectively. If the slope of the mattress is not the user's want, he/she has to elevate the mattress to adjust the shafts again. That is very inconvenient

### SUMMARY OF THE INVENTION

The primary objective of the present invention is to provide an electric mattress, which provides an easier way to adjust the slope of the mattress.

According to the objective of the present invention, an electric mattress comprises a main member made of an elastic material. A frame has a plurality of shafts in the main member. The shafts are rotated to flex and extend the main member a driving device is connected to the shafts to drive the shafts for rotation respectively, and a control device is electrically connected to the driving device for operation.

### BRIEF DESCRIPTION OF THE DRAWINGS

FIG. 1 is a perspective view of a preferred embodiment of the present invention, showing the flat condition of the mattress;

FIG. 2 is another perspective view of the preferred embodiment of the present invention, showing the bent condition of the mattress;

FIG. 3 is a sectional view along the 3-3 line of FIG. 1;

FIG. 4 is a lateral view of the preferred embodiment of the present invention, showing the flat condition of the mattress, and

FIG. 5 is a perspective view of the preferred embodiment of the present invention, showing the application of the mattress;

### DETAILED DESCRIPTION OF THE INVENTION

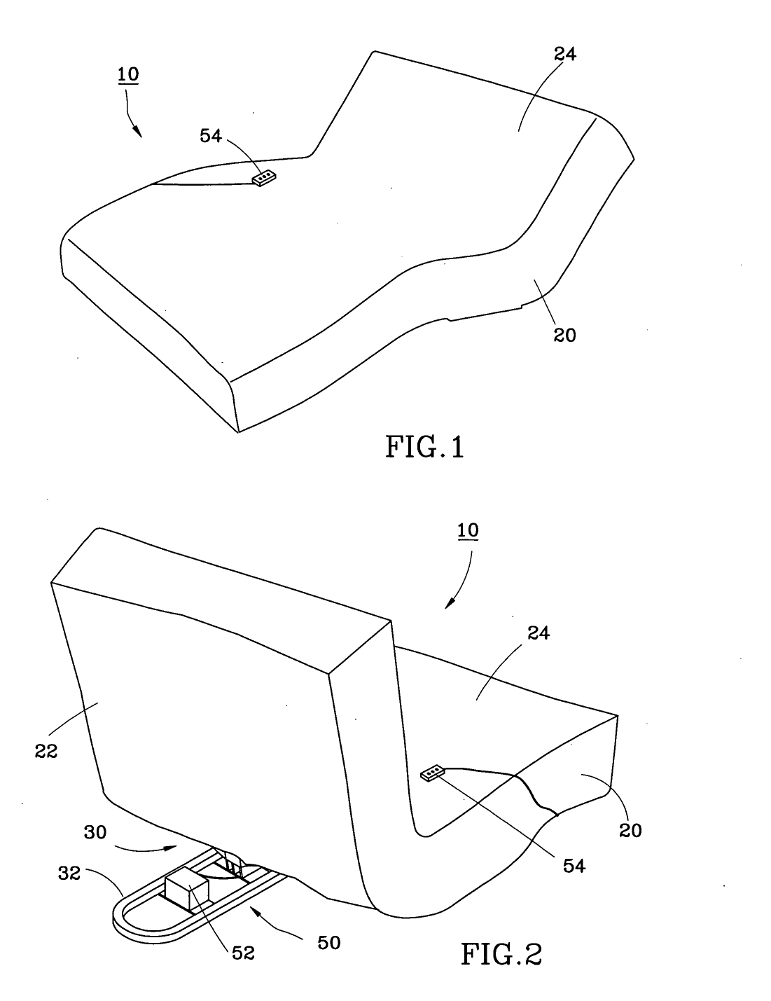

As shown in FIG. 1 to FIG. 3, an electric mattress 10 of the preferred embodiment of the present invention mainly comprises a main member 20, a frame 30, a driving device 40 and a control device 50.

The main member 20 is made of lactoprene with a rectangular sharp.

The frame 30 has a base 32 and a plurality of shafts 34. The shafts 34 are connected to each other and pivoted on the base 32. The base 32 is provided at a bottom of the main member 20, and the shafts 34 are provided in the main member 20. The shafts 34 are provided with a plurality of elastic members 36 to supply the main member 20 having a well supporting capacity at a top 24 thereof.

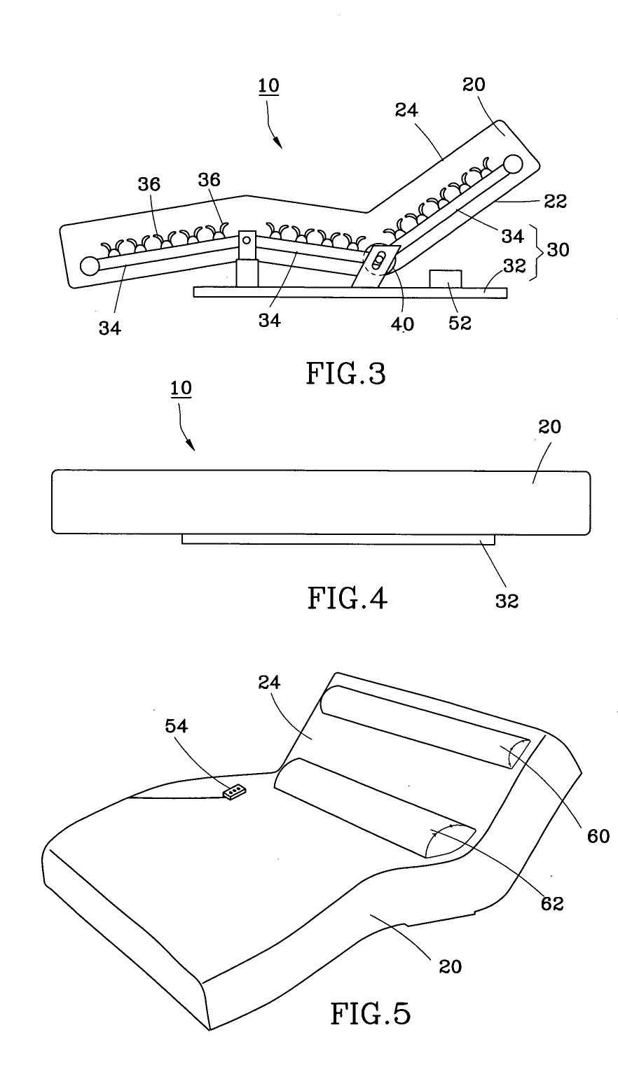

The driving device 40 is a motor in the present invention to drive the shafts 34 of the frame 30 rotating so as to extend the main member 20 to a flat condition (referring to FIG. 4) and to flex the main member 20 to a bent condition (referring to FIG. 3).

The control device 50 has a circuit assembly 52 and a wire controller 54. The circuit assembly 52 is mounted on the base 32 of the frame and electrically connected to the driving device 40. The wire controller 54 is electrically connected to the circuit assembly 52 for operation. User operates the wire controller 54 to rotate the shafts 34 for adjustment of the slope of the main member 20.

The main member 20, the elastic members 36 and frame 30 support people lied on the mattress 10 of the present invention to provide a full-attachment condition. People operates the wire controller 54 to driving the shafts 34 to predetermined position, such that the main member 20 is flexed or extended for a predetermined slope to help people lying or sitting on the mattress 10 of the present invention. As shown in FIG. 3, the mattress 10 of the present invention can be adjusted to have various slopes to meet people's requirement. The mattress 10 of the present invention also can be adjusted to the flat condition, as shown in FIG. 4.

As a result, people can lie on the mattress 10 and adjust the slope thereof without having to get up for adjustment.

The wire controller can be replaced with a wireless controller, and the elastic members can be springs, elastic plates or other elastic devices. FIG. 5 shows the mattress 10 of the present invention provided with two air cells 60 and 62 at the top 24 of the main member 20. The air cells 60 and 62 give a help to support cervical spine and lumbar spine when the mattress 10 of the present invention is adjusted to the bent condition, and people is lying on it. The air cells 60 and 62 are deflated when the mattress 10 of the present invention is adjusted to the flat condition to avoid the air cells 60 and 62 provide extra pressure to people lying on the mattress 10.

What is claimed is:

1. An electric mattress, comprising:
a main member made of an elastic material;
a frame having a plurality of shafts in the main member, wherein the shafts are rotated to flex and extend the main member;
a driving device connected to the shafts to drive the shafts for rotation respectively, and
a control device electrically connected to the driving device for operation.

2. The electric mattress as defined in claim 1, wherein the main member has a top and a bottom, and the frame further has a plurality of elastic members on the shafts below the top of the top of the main member.

3. The electric mattress as defined in claim 1, wherein the main member has a top and a bottom, and the frame further has a plurality of elastic members on the shafts below the top of the top of the main member and a base on the bottom of the member to be connected the shafts.

4. The electric mattress as defined in claim 1, wherein the control device has a circuit assembly on the frame electrically connected to the driving device and a wire controller electrically connected to the circuit assembly.

5. The electric mattress as defined in claim 1, wherein the control device has a circuit assembly on the frame electrically connected to the driving device and a wireless controller electrically connected to the circuit assembly.

6. The mattress as defined in claim 1, wherein the driving device is a motor.

7. The electric mattress as defined in claim 1, wherein the main member has a top and a bottom, on the top of which an air cell is provided associated with a cervical spine of people lying on the main member.

8. The electric mattress as defined in claim 1, wherein the main member has a top and a bottom, on the top of which an air cell is provided associated with a cervical spine of people lying on the main member.

9. An electric mattress, comprising:
a main member made of an elastic material;
at least an air cells provided on the main member to support people's body who lies on the main member;
a frame having a plurality of shafts in the main member, wherein the shafts are rotated to flex and extend the main member;
a driving device connected to the shafts to drive the shafts for rotation respectively, and
a control device electrically connected to the driving device for operation.
